(19) United States
(12) Patent Application Publication
(10) Pub. No.: US 2019/0139132 A1
(43) Pub. Date: May 9, 2019

(54) Method and System for Automatically Processing Corporate Action Events

(71) Applicant: Taiwan Depository & Clearing Corporation, Taipei City (TW)

(72) Inventor: Ching-Li Meng, Taipei City (TW)

(21) Appl. No.: 16/181,371

(22) Filed: Nov. 6, 2018

(30) Foreign Application Priority Data
Nov. 7, 2017 (TW) 106138513

(51) Int. Cl. G06Q 40/00

(52) U.S. Cl. CPC G06Q 40/00

(57) ABSTRACT

The present invention provides a method and system for processing corporate action events by using at least one server to connect multiple overseas custodians and multiple domestic institution, wherein the at least one server classifies multiple corporate action events into multiple corporate action event modules, wherein each of the multiple corporate action event modules has multiple corporate action events each having corresponding multiple predetermined parameters, wherein the at least one server receives messages transmitted by a overseas custodians and determines if a message content contains parameters corresponding to the parameters of one corporate action event of one corporate action event module, so that the at least one server can automatically process the corporate action event and notify the result to a domestic institution corresponding to the corporate action event.

### CROSS-REFERENCES TO RELATED APPLICATIONS

This patent application claims priority of Taiwan Patent Application No. 106138513, filed on Nov. 7, 2017, the entirety of which is incorporated herein by reference.

### BACKGROUND OF THE INVENTION

### I. Field of the Invention

The present invention relates to corporate action events, and more particularly, to a system and method capable of automatically processing corporate action events.

### II. Description of the Prior Art

Domestic institutions invest in cross-border securities and have the securities kept in overseas custodians. Corporate action events are events called by the issuer of securities that affects the security and the holder of the security, such as dividend issuance, cash capital increase, renaming, stock splits, convening of shareholders' meetings, acquisitions, mergers and liquidation. Overseas custodians transmit corporate action events of cross-border securities for viewing by domestic institutions via SWIFT messages. The full name of SWIFT is Society for Worldwide Interbank Financial Telecommunication, which is a global standard financial communication platform. SWIFT messages are exchanged between financial institutions. The message format and content is based on a standard defined by ISO15022. SMPG (The Securities Market Practice Group) defines templates for the corporate action events and describes how to use SWIFT messages to transmit corporate action events for 67 kinds of corporate action events. Because SWIFT messages are hard to read and communications between multiple overseas custodians and multiple domestic institutions are also time-consuming and labor-intensive, human error can occur.

In summary, it can be seen that the inefficient transmission of cross-border corporate action events from overseas custodians has been a long-standing issue in the current technology. Accordingly, there is a need to improve current technology to resolve this issue.

### SUMMARY OF THE INVENTION

One object of the present invention is to provide a method and system for automatically processing of corporate action events from multiple overseas custodians, and notify the domestic institutions of the processing results to improve efficiency and reduce human error.

One object of the present invention is to provide a method and system for processing corporate action events such that multiple overseas custodians and multiple domestic institutions can use a single window to process corporate action events.

In one embodiment, a method for processing corporate action events is disclosed, wherein the method comprises: using at least one server to connect multiple overseas custodians and multiple domestic institutions, wherein the at least one server categorizes multiple corporate action events into multiple corporate action event modules, wherein each of the multiple corporate action event modules has corresponding multiple predetermined corporate action events, wherein each corporate action event has corresponding multiple predetermined parameters to process the corporate action event; and using the at least one server to receive messages transmitted by the multiple overseas custodians, wherein the at least one server receives and determines whether a message content has the multiple parameters corresponding to one corporate action event of one of the multiple corporate action event modules, wherein if the at least one server determines that a message content has the multiple parameters corresponding to a first corporate action event of a first corporate action event module, wherein if the at least one server determines that a message content has the multiple parameters corresponding to a first corporate action event of a first corporate action event module, the at least one server automatically processes the first corporate action event of the first corporate action event module according to the corresponding multiple parameters of the first corporate action event of the first corporate action event module; and using the at least one server to output the processing results of the first corporate action event to a first platform for a domestic institution of the multiple domestic institutions corresponding to the first corporate action event to view.

In one embodiment, the first platform is displayed on a terminal device, such as a computer or a mobile phone.

In one embodiment, the multiple modules comprise a notification-type corporate action event module, a mandatory corporate action event module, a selection-type corporate action event module and other corporate action event module.

In one embodiment, the messages from different sources may not be identical in terms of the multiple parameters of the same corporate action events, and the order of the parameters may also be different.

In one embodiment, the at least one server will set the parameters and flow for processing an undefined corporate action events if the at least one server determines that the message content does not contain the parameters of any corporate action event in the multiple corporate action event modules.

In one embodiment, the at least one server comprises at least one server of a depository.

In one embodiment, the message is a SWIFT message.

In one embodiment, a system for processing corporate action events is disclosed, wherein the system comprises: at least one server, connecting multiple overseas custodians and multiple domestic institutions, wherein the at least one server categorizes multiple corporate action events into multiple corporate action event modules, wherein each of the multiple corporate action event modules has corresponding multiple predetermined corporate action events, wherein each corporate action event has corresponding multiple predetermined parameters to process the corporate action event, wherein the at least one server receives messages transmitted by the multiple overseas custodians and determines whether a message content has the multiple parameters corresponding to one corporate action event of one of the multiple corporate action event modules, wherein if the at least one server determines that a message content has the multiple parameters corresponding to a first corporate action event of a first corporate action event module, the at least one server automatically processes the first corporate action event of the first corporate action event module according to the corresponding multiple parameters of the first corporate action event of the first corporate action event module, and the at least one server outputs the processing results of the first corporate action event to the first platform for a domestic institution of the multiple domestic institutions corresponding to the first corporate action event to view.

In one embodiment, the multiple corporate action event modules comprise a notification-type corporate action event module, a mandatory corporate action event module, a selection-type corporate action event module and other corporate action event module.

In one embodiment, the at least one server comprises at least one server of a depository.

In one embodiment, the first platform is displayed on a terminal device, such as a computer or a mobile phone.

In one embodiment, the at least one server will set the parameters and flow for processing the corporate action if the at least one server determines that the message content does not contain the corresponding multiple parameters of any of the multiple modules.

In one embodiment, the message is a SWIFT message.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 is a schematic diagram illustrating a system for processing corporate action events in accordance with one embodiment of the present invention;

FIG. 2 is a flow chart illustrating a method for processing corporate action events in accordance with one embodiment of the present invention;

FIG. 3 illustrating classifications and contents of multiple corporate action event modules in accordance with one embodiment of the present invention; and

FIG. 4 is a schematic diagram illustrating predetermined parameters of a corporate action event in accordance with one embodiment of the present invention.

### DETAILED DESCRIPTION OF THE INVENTION

The detailed description of the present invention is described below. The described preferred embodiments are for purposes of illustration and description and are not intended to limit the scope of the invention.

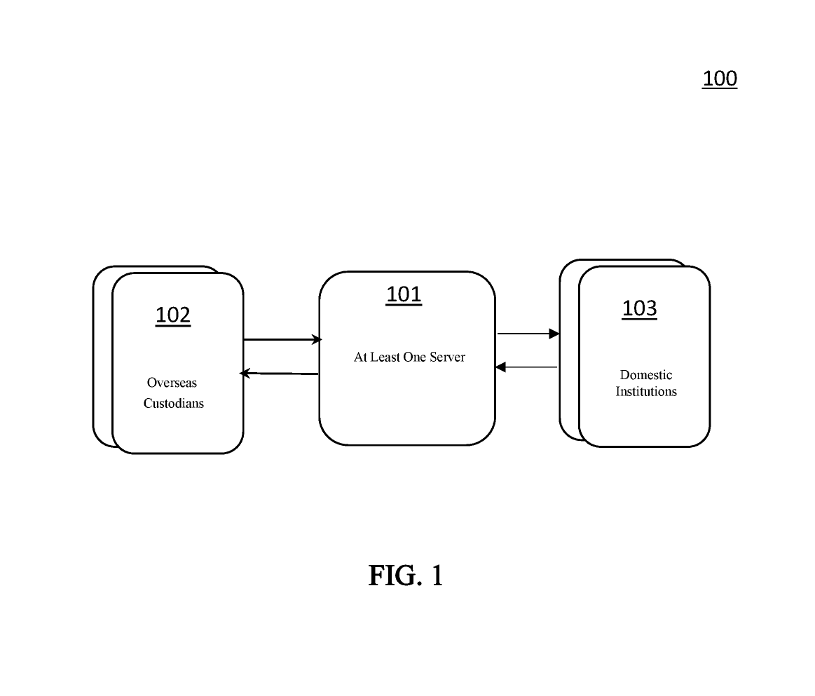

FIG. 1 illustrates a schematic diagram of a system for automatically processing of corporate action events from multiple overseas custodians and notifying a corresponding domestic institution of the processing results of the corporate action events. As shown in FIG. 1, the system 100 comprising at least one server 101 connecting multiple overseas custodians 102 and multiple domestic institutions 103, wherein the at least one server 101 categorizes multiple corporate action events into multiple corporate action event modules, wherein each of the multiple corporate action event modules has corresponding multiple predetermined corporate action events, wherein each corporate action event has corresponding multiple predetermined parameters to process the corporate action event, wherein the at least one server 101 receives SWIFT messages transmitted by the multiple overseas custodians 102, wherein the at least one server 101 determines whether a SWIFT message content contains the multiple parameters corresponding to one corporate action event of one of the multiple corporate action event modules, wherein if the at least one server 101 determines that a SWIFT message content has the multiple parameters corresponding to a first corporate action event of a first corporate action event module, the at least one server 101 automatically processes the first corporate action event of the first corporate action event module according to the corresponding multiple parameters of the first corporate action event of the first corporate action event module; and the at least one server 101 outputs the processing results of the first corporate action event to a first platform for viewing by a domestic institution of the multiple domestic institutions 103 corresponding to the first corporate action event.

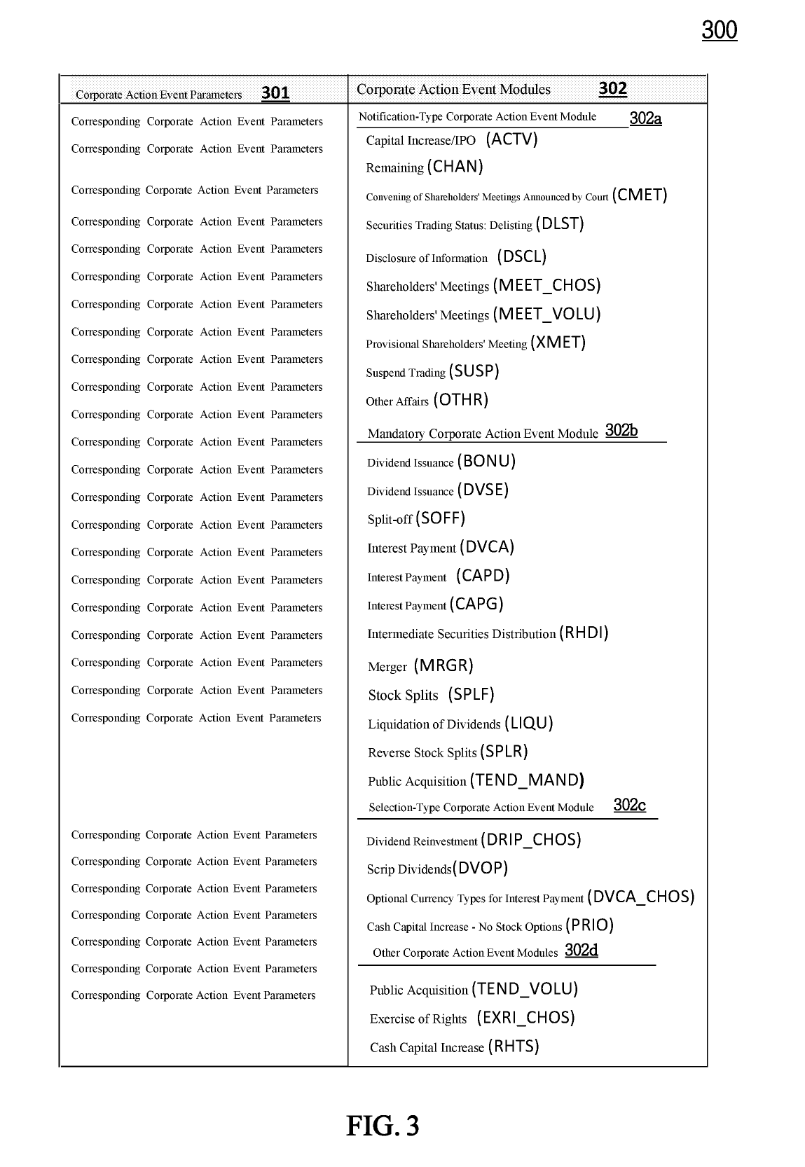

In one embodiment, FIG. 3 illustrates the classifications and contents of the multiple corporate action event modules. As shown in FIG. 3, the multiple corporate action event modules 302 can be categorized into a notification-type corporate action event module 302a, a mandatory corporate action event module 302b, a selection-type corporate action event module 302c and other corporate action event module 302d, wherein the notification-type corporate action event module 302a defines 10 corporate action events, the mandatory corporate action event module 302b defines 12 corporate action events, the selection-type corporate action event module 302c defines 4 corporate action events, and the other-type corporate action event modules 302d defines 3 corporate action events, and wherein each corporate action event has corresponding predetermined corporate action events parameters 301. The overseas custodians 102 transmit corporate action events in standardized messages (such as SWIFT messages) for cross-border securities. Upon receiving the SWIFT messages, the at least first server 101 separates them into independent corporate action events, wherein the important information of each SWIFT message is converted into Chinese in a standard form through a corresponding corporate action event module for generating a report for viewing by a corresponding domestic institution of the multiple domestic institutions 103.

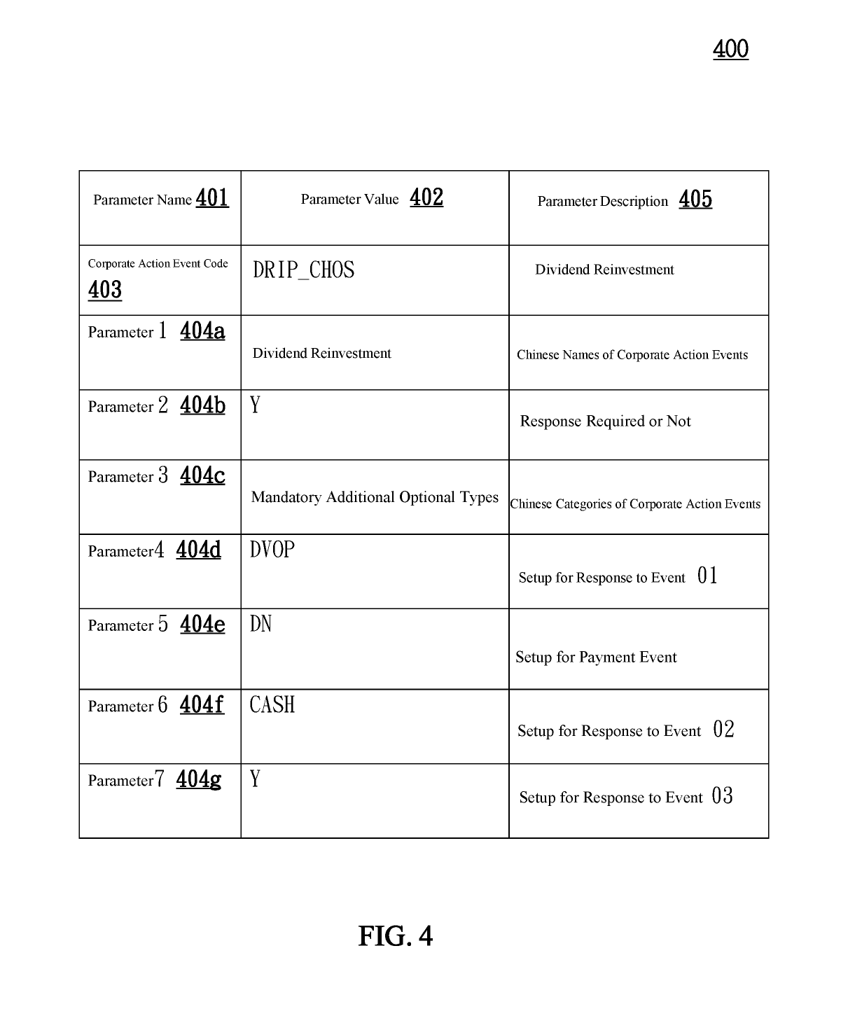

In one embodiment, FIG. 4 illustrates a schematic diagram of the multiple predetermined parameters of a corporate action event, such as a dividend reinvestment event of a selection-type corporate action event module 302c, wherein the dividend reinvestment event has three fields: parameter name 401, parameter value 402 and parameter description 405. The dividend reinvestment event has a corporate action event code 403 and the corresponding multiple parameters 404a, 404b, 404c, 404d, 404e, 404f, 404g. In one embodiment, the corresponding multiple parameters are predetermined by the at least one server 101.

In one embodiment, the processing results of the first corporate action event are outputted to a first platform for viewing by a domestic institution of the multiple domestic institutions 103 corresponding to the first corporate action event.

In one embodiment, the at least one server will determine the corporate action events parameters and flow for processing an event in the SWIFT message if the at least one server determines that the SWIFT message does not contain corresponding multiple parameters of any corporate action event in the multiple corporate action event modules.

In one embodiment, the multiple domestic institutions comprise financial institutions.

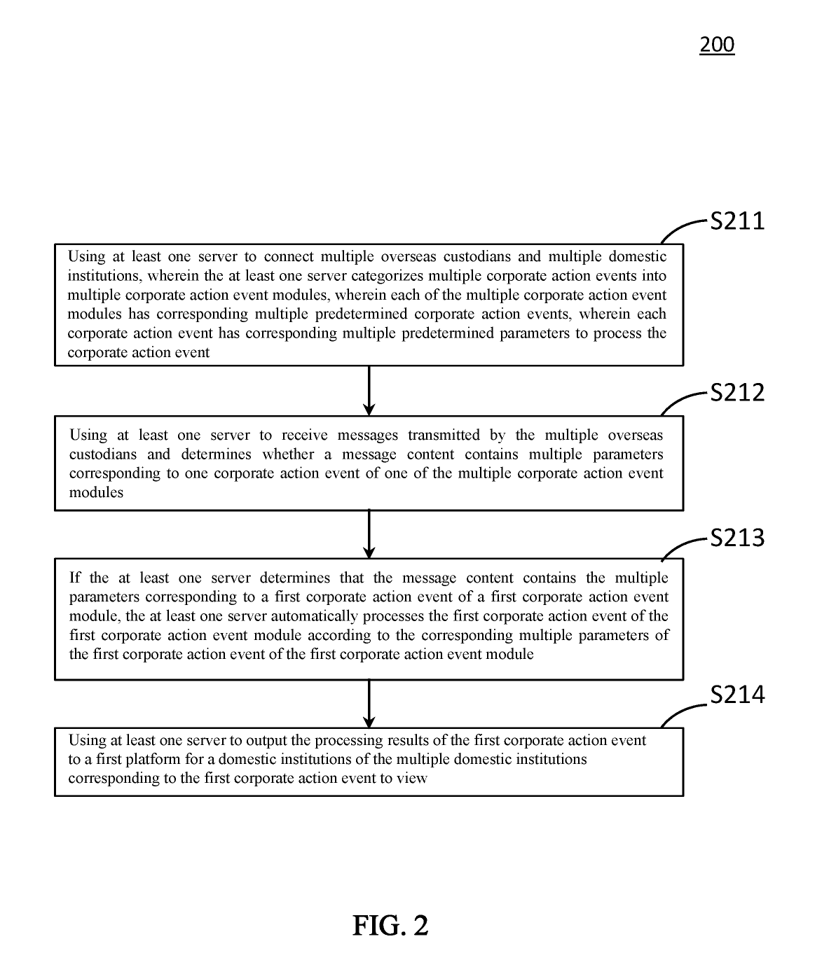

FIG. 2 illustrates a method for automatically processing of corporate action events from multiple overseas custodians in accordance with one embodiment of the present invention. Please refer to FIGS. 1 and 2. The method for automatically processing of corporate action events from multiple overseas custodians comprises the following steps. In step S211, using at least one server to connect multiple overseas custodians and multiple domestic institutions, wherein the at least one server 101 categorizes multiple corporate action events into multiple corporate action event modules, wherein each of the multiple corporate action event modules has corresponding multiple predetermined corporate action events, wherein each corporate action event has corresponding multiple predetermined parameters to process the corporate action event. In step 212, the at least one server receives the messages transmitted by the multiple overseas custodians and determines whether a message content contains multiple parameters corresponding to one corporate action event of one of the multiple corporate action event modules. In step 213, if the at least one server determines that the message content has the multiple parameters corresponding to a first corporate action event of a first corporate action event module, the at least one server automatically processes the first corporate action event of the first corporate action event module according to the corresponding multiple parameters of the first corporate action event of the first corporate action event module. In step 214, the at least one server outputs the processing results of the first corporate action event to a first platform for viewing by a domestic institution of the multiple domestic institutions corresponding to the first corporate action event.

In one embodiment, FIG. 3 illustrates the classifications and contents of the multiple corporate action event modules. As shown in FIG. 3, the multiple corporate action event modules 302 can be categorized into a notification-type corporate action event module 302a, a mandatory corporate action event module 302b, a selection-type corporate action event module 302c and other corporate action event module 302d, wherein the notification-type corporate action event module 302a defines 10 corporate action events, the mandatory corporate action event module 302b defines 12 corporate action events, the selection-type corporate action event module 302c defines 4 corporate action events, and the other-type corporate action event modules 302d defines 3 corporate action events, and wherein the corporate action events of each corporate action event module has predetermined corporate action events parameters 301. The overseas custodians 102 transmit corporate action events in standardized messages (SWIFT messages) for cross-border securities. Upon receiving the SWIFT messages, the at least first server 101 separates them into independent corporate action events, wherein the important information of each SWIFT message is converted into Chinese in a standard form through the corporate action event module for generating a report to the domestic institutions 103.

In one embodiment, FIG. 4 illustrates a schematic diagram of the multiple predetermined parameters of a corporate action event, such as a dividend reinvestment event of a selection-type corporate action event module 302c, wherein the dividend reinvestment event has three fields: parameter name 401, parameter value 402 and parameter description 405. The dividend reinvestment event has a corporate action event code 403 and the corresponding multiple parameters 404a, 404b, 404c, 404d, 404e, 404f, 404g. In one embodiment, the corresponding multiple parameters are predetermined by the at least one server 101.

In one embodiment, the processing results of the first corporate action event are output to a first platform for viewing by a domestic institution of the multiple domestic institutions corresponding to the first corporate action event.

In one embodiment, the at least one server will be used to set up the corporate action event parameters and flow for processing an event in the SWIFT message if the at least one server determines that the SWIFT message does not contain corresponding multiple parameters of any corporate action event in the multiple corporate action event modules.

In one embodiment, the overseas custodians 102, such as a foreign custodian (e.g. Euroclear, Clearstream, JP Morgan), sends a SWIFT message for notifying a corporate action event. SWIFT GateWay receives the SWIFT message from the foreign custodian and forwards the SWIFT message to the cross-border custodian system of the at least one server 101. The cross-border custodian system of the at least one server 101 receives the SWIFT message and performs SWIFT message analysis according to the overseas custodian SWIFT BIC CODE, MT564 SWIFT message parameter, MT566 SWIFT message parameter, MT568 SWIFT message parameter and stores the analyzed SWIFT message into the database. The cross-border custodian system analyzes the type of corporate action event based on the corporate action event parameters corresponding to the analyzed event in the SWIFT message. The follow-up corporate action event maintenance is carried out for the defined corporate action events. If there is an undefined corporate action event, corresponding corporate action events parameters and a corresponding flow for processing the undefined corporate action event will be set up. Through the “corporate action events maintenance” of the cross-border custodian system, confirmation of information on the corporate action event is carried out. After the confirmation of the corporate action events is completed, the system is able to process the corresponding corporate action event based on the corporate action event type. After the completion of the confirmation of the corporate action event, the system generates operation items for the corporate action event according to the type and the flow of the corporate action event, and then the operation items of the corporate action event can be automatically executed by the system. A participant can receive notification of the processing results of corporate action events through cross-border custodian system.

In one embodiment, the multiple domestic institutions comprise financial institutions.

In one embodiment, the at least one server comprises at least one server of a depository. The software and hardware architecture of the method and system for automatically processing the corporate action events. The system, in the present invention, for automatically processing corporate action events can use load balancing architecture with multiple servers to achieve high availability. Through this mechanism, the traffic load can be distributed equally to each server to achieve load balancing. If one server is shut down in the group, the load balancing will direct the load of the failed server to other servers, thereby providing uninterrupted network services. The use of a server load balancing architecture provides the following benefits: increased reliability, improved server service performance, easier server management, and independence of hardware architecture or operating systems.

The method and system, in the present invention, for automatically processing corporate action events has numerous advantages. Corporate action events from multiple overseas custodians can be automatically processed, and the corresponding domestic institution are notified of the processing results to improve efficiency and reduce human error. Also, multiple overseas custodians and multiple domestic institutions can use a single window to process corporate action events.

While the invention has been described in connection with the preferred embodiments, it is not intended to limit the scope of the invention. Any person skilled in the art can make some changes and modifications without departing from the spirit and scope of the present invention. The scope of the patent protection of the invention hence shall be subject to the definition of the scope of the patent application attached hereto.

What is claimed is:

1. A method for processing corporate action events, said method comprising:
using at least one server to connect multiple overseas custodians and multiple domestic institutions, wherein the at least one server categorizes multiple corporate action events into multiple corporate action event modules, wherein each of the multiple corporate action event modules has corresponding multiple predetermined corporate action events, wherein each corporate action event has corresponding multiple predetermined parameters to process the corporate action event; and
using the at least one server to receive messages transmitted by the multiple overseas custodians, wherein the at least one server receives and determines whether a message content has the multiple parameters corresponding to one corporate action event of one of the multiple corporate action event modules, wherein if the at least one server determines that a message content has the multiple parameters corresponding to a first corporate action event of a first corporate action event module, wherein if the at least one server determines that a message content has the multiple parameters corresponding to a first corporate action event of a first corporate action event module, the at least one server automatically processes the first corporate action event of the first corporate action event module according to the corresponding multiple parameters of the first corporate action event of the first corporate action event module; and
using the at least one server to output the processing results of the first corporate action event to a first platform for a domestic institution of the multiple domestic institutions corresponding to the first corporate action event to view.

2. The method according to claim 1, wherein the multiple modules comprise a notification-type corporate action event module, a mandatory corporate action event module, a selection-type corporate action event module and other corporate action event module.

3. The method according to claim 1, wherein the messages from different sources may not be identical for the multiple parameters of the same corporate action events, and the order of the parameters may also be different.

4. The method according to claim 1, wherein the at least one server will determine the corporate action event parameters and process for the event of the message if the at least one server determines that the message content does not have multiple parameters corresponding to any of the multiple modules.

5. The method according to claim 1, wherein the at least one server comprises at least one server of a depository.

6. The method according to claim 1, wherein the message is a SWIFT message.

7. A system for processing corporate action events, said system comprising:
at least one server, connecting multiple overseas custodians and multiple domestic institutions, wherein the at least one server categorizes multiple corporate action events into multiple corporate action event modules, wherein each of the multiple corporate action event modules has corresponding multiple predetermined corporate action events, wherein each corporate action event has corresponding multiple predetermined parameters to process the corporate action event, wherein the at least one server receives messages transmitted by the multiple overseas custodians and determines whether a message content has the multiple parameters corresponding to one corporate action event of one of the multiple corporate action event modules, wherein if the at least one server determines that a message content has the multiple parameters corresponding to a first corporate action event of a first corporate action event module, the at least one server automatically processes the first corporate action event of the first corporate action event module according to the corresponding multiple parameters of the first corporate action event of the first corporate action event module, and the at least one server outputs the processing results of the first corporate action event to a first platform for a domestic institution of the multiple domestic institutions corresponding to the first corporate action event to view.

8. The system according to claim 7, wherein the multiple modules comprise a notification-type corporate action event module, a mandatory corporate action event module, a selection-type corporate action event module and other corporate action event module.

9. The system according to claim 7, wherein the at least one server comprises at least one server of a depository.

10. The system according to claim 7, wherein the at least one server will be used to set up the corporate action event parameters and flow for processing an event in the message if the at least one server determines that the message does not contain corresponding multiple parameters of any corporate action event in the multiple corporate action event modules.

11. The system according to claim 7, wherein the message is a SWIFT message.
